(19) United States
(12) Patent Application Publication
(10) Pub. No.: US 2007/0077543 A1
(43) Pub. Date: Apr. 5, 2007

(54) CBM progress monitoring software

(76) Inventors: Seajae Hartness, Hattiesburg, MS (US); Odell George Vining, Hattiesburg, MS (US)

Correspondence Address: Vinning-Hartness Company, 104 Chickasaw Dr., Hattiesburg, MS, 39401, US

(21) Appl. No.: 11/243,433

(22) Filed: Oct. 5, 2005

(51) Int. Cl. G09B 5/00

(52) U.S. Cl. 434/169

(57) ABSTRACT

What is new about the invention is that a computer program can now be used to assess oral fluency, and automatically save the data into a database. Before creation of this program, oral fluency was measured using pencil/pen and paper. Calculation of scores was done manually. Now, the program determines/calculated the fluency score.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER DISC APPENDIX

Not Applicable

### BACKGROUND OF THE INTERVENTION

This invention pertains to progress monitoring by the field of academics and/or school psychology (Dunn & Eckert, 2002 Curriculum-Based Measurement in Reading: A Comparison of Similar Versus Challenging Material. School Psychology Quarterly; Deno, 1985 Curriculum-Based Measurements: The Emerging Alternative. Exceptional Children) Historical limitations to administration of curriculum-based measurement (CBM) has been administration time and error. The proposed invention will reduce the administration time and error in proctoring CBM measurements (in oral reading fluency, letter, and letter sounds).

### BRIEF SUMMARY OF THE INVENTION

The invention is a software program that allows an examiner to use a computer to conduct progress monitoring/assessment of word, letter, letter sound, and number oral fluency. Oral fluency is how fast and accurately a person can read aloud.

### BRIEF DESCRIPTION OF THE SEVERAL VIEWS OF THE DRAWING

Not Applicable

### DETAILED DESCRIPTION OF THE INVENTION

The invention is the first computerized tool for assessing oral reading, letter, letter sound, and number identification oral fluency. Oral fluency is how fast a person can read aloud (e.g. words for oral reading and letters for letter fluency). Before the invention, fluency of oral reading, letter, letter sound, and number identification was assessed by paper and pencil. The examiner would provide the examinee a paper with the content to be assessed (e.g. words, letters) and the examiner would mark on a copy of the paper the words, letters, letter sounds, or numbers the person was unable to correctly read aloud. This was done for one minute. After one minute the examiner would count how many words, letters, letter sounds, or numbers the person read correctly and subtract the number of errors they made. This yielded a fluency score.

The invention is a computer program that allows the examiner to click on words, letters, letter sounds, or numbers as the examinee misses them. Furthermore the invention allows the examiner to double click the last word, letter, letter sound, or number the examinee read. The invention then automatically calculates fluency scores and saves them in a database. The invention also saves missed words, letters, letter sounds, and numbers into a database.

We claim:

I. Using a palm pilot, notebook pc, tablet pc, or desktop pc, the examiner engages in the unique process of clicking on (a) words, (b) letters, (c) letter sounds, or (d) numbers that are either read incorrectly or not verbalized in “x” seconds (e.g. words taking longer than 3-seconds to verbalize).

II. Invention produces the number of correct words, letters, sounds, or numbers correctly identified within a given time period (e.g. correct words per minute), as determined by the total words/letters/sounds read, minus incorrect words/letters/sounds/numbers.

III. Software saves (a) number of correct words, letters, sounds, or numbers correctly identified per minute, (b) the missed words, letters, letter sounds, and numbers into a database.
1. Converts oral fluency raw score into a standard score.
2. Based on user's oral fluency data, forms an trend line for growth
3. Predicts values that a user will have on a assessment/test as determined by the users' fluency data on that year, as well as users' fluency scores from previous years.
4. Graphs the oral fluency (e.g. oral reading fluency) score.
